(19) United States
(12) Patent Application Publication
(10) Pub. No.: US 2012/0020341 A1
(43) Pub. Date: Jan. 26, 2012

(54) Method for downloading predetermined entertainment content to customers

(75) Inventors: Douglas S. Moeller, Santa Rosa, CA (US); Ronald W. Pashby, San Francisco, CA (US)

(73) Assignee: AUTONET MOBILE, INC., San Francisco, CA (US)

(21) Appl. No.: 13/136,574

(22) Filed: Aug. 4, 2011

Related U.S. Application Data
(63) Continuation-in-part of application No. 12/514,054, filed on Jan. 12, 2010, now Pat. No. 8,072,994.

(51) Int. Cl. H04W 40/00

(52) U.S. Cl. 370/338

(57) ABSTRACT

A method is provided for providing digital entertainment to a customer having a mobile router comprising a first wireless local area network having a customer mobile device coupled thereto. The method comprises: providing a source of the digital entertainment data; coupling the source to the customer mobile device via the router and the first wireless local area network; operating the source with the router such that the source automatically downloads predetermined digital entertainment data to the customer mobile device via the wireless local area network and the router.

### CROSS-REFERENCE TO RELATED APPLICATIONS

The present application is a continuation-in-part of U.S. patent application Ser. No. 12/514,054 filed as PCT Application No. PCT/US07/11631 on May 15, 2007 and claiming priority to U.S. provisional application Ser. No. 60/800,749, filed May 16, 2006, U.S. provisional application Ser. No. 60/800,679, filed May 16, 2006 and U.S. provisional application Ser. No. 60/800,750, filed May 16, 2006.

### FIELD OF THE INVENTION

The present invention relates to a wireless network router that interfaces wirelessly with a wide area network and forms a wireless local area network, in general, and to a wireless network router configured for mobile use with a mobile device, in particular.

### BACKGROUND

Many people use mobile or wireless end-user computer-type devices for a variety of purposes. These devices include smart phones, handheld computer-type devices, personal digital assistants (PDAs), laptop computers equipped with a wireless network interface card, and similar devices. Users often use such devices to read and write email messages, access the Internet, download and view image or video files, and run applications, among other uses.

To use such mobile devices, the devices must be able to connect to a wireless network. Wireless local area networks (LANs) are often deployed inside structures such as homes, offices, public and commercial buildings. A typical wireless LAN comprises one or more wireless access points, such as a wireless router or “hot spot”, which communicates wirelessly with the mobile device, and allows the mobile device to connect to a wired network or other network that is also in communication with the access point. To stay connected to such a wireless LAN, the mobile device must usually stay within wireless communication range of the access points. This constrains the effective mobility of a wireless device. The mobile device must stay in the home, office or building to have wireless access to the wireless LAN. If the mobile device leaves the premises, the mobile device may leave the range of the wireless access points and thereby lose connectivity to the network. One commonly used wireless network industry standard is the IEEE 802.11 standard, also known as Wi-Fi. For Wi-Fi, the range of such access points is about 50 meters for indoor environments and 100 meters for outdoor environments.

Some campuses and urban areas provide broader WiFi coverage areas by placing a number of cooperating WiFi hot spots throughout the campus or urban area. This provides the mobile device with greater wireless access as the mobile device generally can move around the campus/urban area while maintaining wireless connectivity. However, when the mobile device leaves the campus/urban area connectivity may be lost, thus constraining the wireless mobility of the user.

The mobility constraining problem has been addressed somewhat by use of cellular networks that allow mobile devices to communicate wireless data with such cellular networks using data communication standards, such as GSM/GPRS (Global System for Mobile Communications/General Packet Radio Service), EDGE (Enhanced Data rates for GSM Evolution) or LTE (Long Term Evolution). Such cellular networks generally provide much broader coverage areas than wireless LANs or Wi-Fi area, so a mobile device will ordinarily have fewer restrictions on mobility when accessing such a cellular network. Further, cellular networks typically can accommodate roaming users by allowing devices to stay connected as they travel from one cellular network to another.

Mobile user devices often experience interruptions in service due to drop-offs by the network whether the network is Wi-Fi or a cellular network. The problem is exacerbated when a user device is quickly moving between network cells, hot spots or networks.

In addition, a mobile user device may experience other types of performance problems, including a change of bit rate or bandwidth during the data transmission, and a change in the quality of service (e.g., jitter, latency, data loss, etc.).

### SUMMARY

In one embodiment of the invention a method is provided for utilizing a mobile router of a type comprising a local area network interface comprising a first wireless transceiver of a predetermined type to provide a link to a local area network, a wide area network interface comprising a second wireless transceiver of a second predetermined type to provide a link to a wide area network, a processor to control operation of the router, and a memory comprising programs executable by the processor. The method comprises selectively operating the router as a wireless local area network access point for a first mobile device utilizing the first transceiver to access the Internet via a wide area network and said second transceiver; selectively operating the router as a local area network client utilizing the first transceiver for the first mobile device to access download sources accessed via said local area network transceiver; automatically downloading predetermined data to the first mobile device from a second client device; and automatically synchronizing the downloading of the predetermined data.

Further in accordance with the embodiment entertainment source data is provided as the predetermined data.

Yet further in accordance with the embodiment the second client and the first mobile device cooperate to automatically synchronize downloading of the predetermined data from the second client device to the first mobile device.

Even further in accordance with the embodiment, the method includes selecting the second client as a commercial enterprise and selecting the first mobile device as a customer of the commercial enterprise.

Further in accordance with the invention, the method comprises providing the first client with identification information and operating the second client to automatically verify the identification information prior to the automatic downloading.

A method of operating a mobile router comprising a local area network transceiver and a wide area network transceiver comprises selectively operating the mobile router as a wireless local area network access point for a mobile device to access the Internet via wide area network wireless transceiver; selectively operating the mobile router as a local area network client utilizing said transceiver for the mobile device to access a download source accessed via the local area network transceiver; and automatically downloading predetermined data to the mobile device from a second client device.

Further in accordance with the embodiment video data is provided as the predetermined data.

A method for providing videos to customers, comprises providing a source of the videos as digital data; providing the source with a first wireless transceiver of a predetermined type utilizable in local area networks; detecting a mobile router having a second wireless transceiver of the predetermined type to provide a link to a local area network, the local area network comprising a customer mobile device; and operating the video source and router such that the video source automatically downloads video digital data to the customer mobile device via the wireless local area network and the router.

A method for providing digital entertainment to a customer having a mobile router comprising a first wireless local area network having a customer mobile device coupled thereto comprises: providing a source of the digital entertainment data; coupling the source to the customer mobile device via the router and the first wireless local area network; operating the source with the router such that the source automatically downloads predetermined digital entertainment data to the customer mobile device via the wireless local area network and the router.

### BRIEF DESCRIPTION OF THE DRAWING

The invention will be better understood by reading the following detailed description in conjunction with the drawing figures in which like designators refer to like elements, and in which:

FIG. 1 is a block diagram of a first network arrangement including a mobile router;

FIG. 2 is a block diagram of a mobile router;

FIG. 3 is a flow diagram of the process flow of a link monitor program module;

FIG. 4 is a second block diagram of the mobile router of FIG. 2;

FIG. 5 is a block diagram of a second network arrangement;

FIG. 6 is a flow diagram;

FIG. 7 is a block diagram of a third network arrangement;

FIG. 8 is a flow diagram;

FIG. 9 is a flow diagram illustrating a download via the router of FIG. 5;

FIG. 10 is a second flow diagram illustrating a download via the router of FIG. 5; and

FIG. 11 is a flow diagram of operation of a power control function of the router of FIG. 5

### DETAILED DESCRIPTION

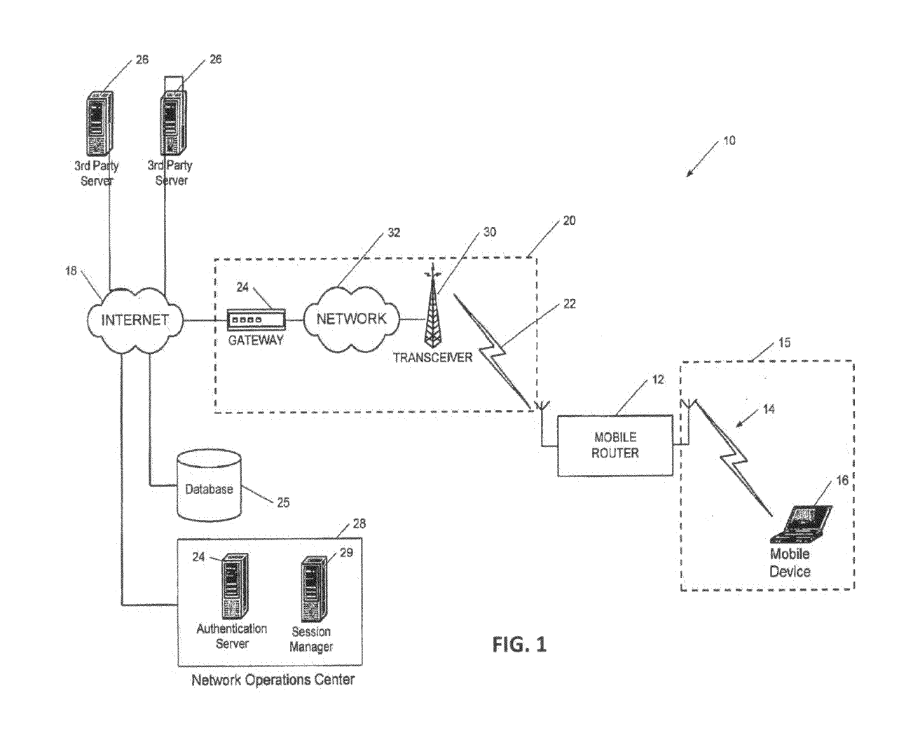

FIG. 1 is a diagram of a network 10. Network 10 comprises a mobile router 12 in communication with a mobile device 16 via a wireless communication link 14. A wireless local area network 15 includes mobile router 12 and mobile device 16. Wireless local area network 15 may be, for example, a network compliant with industry standard IEEE 802.11 network, i.e., a WiFi network, or a network compliant with industry standard IEEE 802.16, i.e., a WiMAX network, or a Bluetooth network, or any other suitable wireless network.

Mobile device 16 may be any computer processor based device having a wireless transceiver capable of receiving and transmitting data via the wireless communication link 14. For example, mobile device 16 may be a laptop (or notebook) computer equipped with a wireless network interface card, a wireless-enabled PDA, a pocket or palmtop computer, a WiFi phone (e.g., a Skype phone or VoIP phone), a WiFi appliance, a Sony PlayStation PSP or some other portable, network-enabled gaming station, a video screen, a digital camera, an audio player, a navigation device, a security camera, an alarm device, a wireless payment or POS device, or an automotive electronic device.

The mobile router 12, as explained further, may act as a gateway between wireless network 15 and a backhaul network 20. Backhaul network 20 in turn may be connected to the Internet 18 or any other network, such as an intranet or another WAN, via a gateway 24.

Mobile router 12 communicate with the backhaul network 20 via a backhaul wireless communication link 22. Backhaul wireless communication link 22 may be provided by a wireless network that is part of the backhaul network 20, such as a cellular wireless network. The cellular wireless network may be of any type.

Examples of such types of cellular network, include but are not limited to the following types: a Global System for Mobile Communications/General Packet Radio Service (GSM/GPRS) link; a UMTS (Universal Mobile Telecommunications System) link; a Code Division Multiple Access (CDMA) link; an Evolution-Data Optimized (EV-DO) link; an Enhanced Data Rates for GSM Evolution (EDGE) link; a 3GSM link; a Long Term Evolution (LTE) link, a Digital Enhanced Cordless Telecommunications (DECT) link; a Digital AMPS (IS-136/TDMA) link; an Integrated Digital Enhanced Link (iDEN) link; a WiMAX link; or any other suitable wireless link.

Mobile router 12 and mobile device 16 are co-located in a vehicle, that is not shown, so that mobile router 12 is capable of being mobile and so that end-users of the mobile device 16 can enjoy wireless connectivity to Internet 18 via mobile router 12 as the vehicle travels through cells or nodes associated with wireless network 22. The moving vehicle could be any land, water, or air based vehicle.

Mobile router 12 may be mounted to the vehicle in a secure and generally tamper-resistant location. For example, the mobile router 12 may be mounted in the trunk of an automobile, and the end-user of the mobile device 16 may be a passenger or driver of the automobile. That way, the end-user could enjoy wireless connectivity as the automobile moves between cells of the wireless network 22.

Although only one mobile device 16 is shown in communication with the mobile router 12 in FIG. 1, numerous mobile devices 16 may be in communication with the mobile router 12 via network 14.

Mobile router 12 does not necessarily need to be installed in, affixed to, or otherwise placed in a mobile vehicle. For example, a user could use the mobile router 12 at home, work, or any other stationary location, or carry the mobile router 12.

As shown in FIG. 1, a transceiver 30 may receive and transmit the wireless signals to the mobile router 12 via the wireless communication link 22. A communication network 32 of the backhaul network 20 may communicate with the Internet 18 (or other network) via one or more gateways 24. The communication network 32 may include conventional network elements such as servers, routers, switch, etc., and may provide wireless network service for the mobile router 12. Of course, although only one transceiver 30 is shown in FIG. 1, it should be recognized that the backhaul network 20 may comprise a number of such transceivers, located in different areas serviced by the backhaul network 20, such that the mobile router 12 may stay in communication with the backhaul network 20 as the mobile router 12 moves between cells or nodes of the backhaul network 20.

Third party servers may be in communication with the Internet 18. Mobile device 16 can access the third party servers through the mobile router 12 and the backhaul network 20.

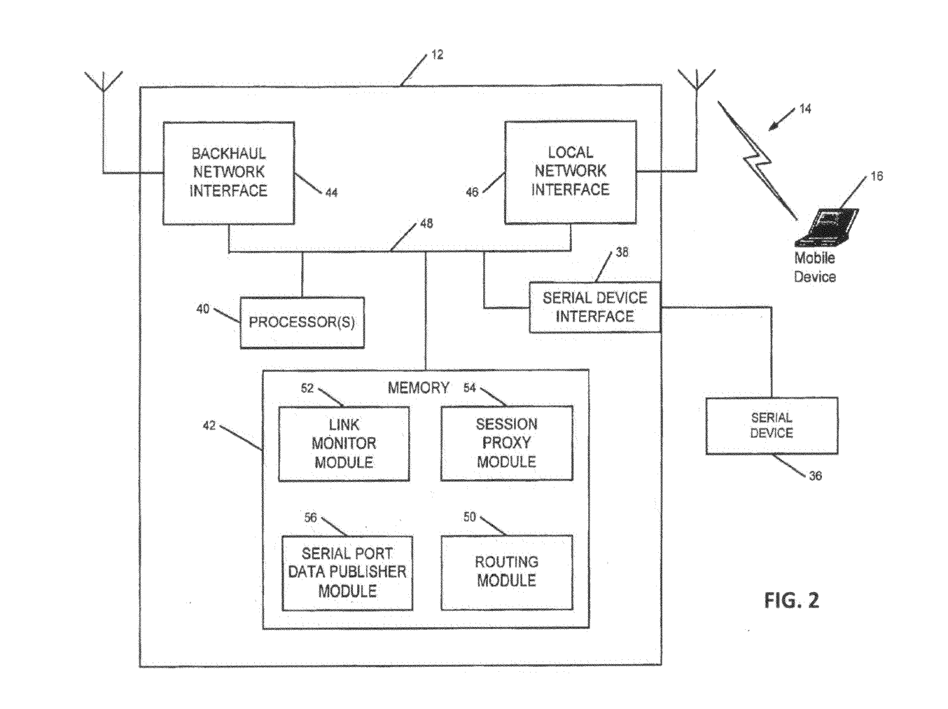

FIG. 2 is a simplified block diagram of the mobile router 12. Mobile router 12 may comprise one or more processors 40, one or more memory units 42, a backhaul network interface 44, and a local network interface 46. A system bus 48 interconnects the one or more processors 40, memory units 42, backhaul network interface 44 and local network interface 46. Mobile router 12 also comprises one or more serial interfaces 38 that interface to a serial bus. In the embodiment shown, the serial bus connects to a serial device 36.

It will be appreciated by those skilled in the art that the block diagram of mobile router 12 does not include conventional components of a router.

Backhaul network interface 44 interfaces with and provides a wireless communication link with backhaul network 20. Local network interface 26 interfaces and provides a wireless communication link with wireless network 15. Backhaul network interface 44 may interface with one or more types of wireless communication link 22. For example, the backhaul network interface 44 may be any one or more of a GSM/GPRS interface, a UTMS interface, an LTE interface, an EDGE interface, and a WiMAX interface.

Similarly, local network interface 46 may interface to one or more types of wireless network 15 such as a WiFi, WiMAX, or Bluetooth interface.

Processor 40 may execute various programs or instruction code stored in memory 42. Memory 42 may comprise one or more types of computer-readable media. As such, memory 42 may comprise one or more memory chips, optical memory devices, magnetic memory devices, or other memory devices.

Various programs or program modules are executable by processor 40. The program modules include a routing module 50, a link monitor module 52, a session proxy module 54, and a serial port data publisher module 56. The program modules 50, 52, 54, 56 may be stored in portions of memory 42 or in one or move separate memories.

Routing program 50 is executed by processor 40 to route data packets between wireless network 15 and backhaul network 20. Link monitor program 52 monitor cellular communication links (layer 2) and also Internet communication links (layer 3) via backhaul network 20 by sending test or probing data packets and monitoring for responses thereto. By monitoring the sending and receiving of test packets and responses, link monitor program 52 detects if either (or both) of the links fails.

When processor 40, executing link monitor module 52, detects a drop-off, the link is reestablished to minimize the interruption in service to the end user. In many prior art mobile routers, when communications links are lost, the end-user's applications and network sessions are terminated. The end-user has to restart the applications and/or session when the communications links and network connection are reestablished.

When processor 40 detects a failure in one or both of the communications link or Internet link, processor 40 initiates remedial action by attempting to reestablish the link or links. It may reestablish the link before applications on the mobile device 16 have to be restarted. That way, the user does not have to restart the applications or sessions. The user just typically notices that the applications/sessions slowed for a brief period of time while the connection was being reestablished.

Link monitor module 52 as executed on processor 40 provides adaptive programming. If backhaul network interface 44 receives data packets over backhaul wireless communication link 22, processor 40 sends less probing test data packets. Conversely, if backhaul network interface 44 does not receive data packets processor 40 sends more probing test data packets. By monitoring data packets received via backhaul network interface 44, processor 40 determines that the interface is functioning. Accordingly processor 40 sends data test packets less frequently.

Processor 40, executing link monitor module 52, monitors backhaul network interface 44 to determine that data packets are received. If processor 40 determines that backhaul wireless communication link 22 is working, then processor 40 sends fewer active probes on the backhaul network 20.

Cellular network users frequently lose data connections. In the absence of utilizing mobile router 12, when a cellular network connection with a mobile device 16 is lost, applications running on the mobile device 16 stop running, and have to be restarted when the TCP session is re-established.

Processor 40, by executing session proxy module 54 acts as a session proxy for all TCP sessions going through the mobile router 12. When a mobile device 14 seeks to establish a TCP session with a destination such as a third party server connected to network 18, processor 40 terminates the TCP session coming from the mobile device 16 and, instead, establishes a TCP session via backhaul network interface 26 with the destination. Mobile router 12 also maintains a separate TCP session with mobile device 16 via local wireless communication link 14.

All end-user traffic between mobile device 14 and the destination is transparently routed through mobile router 12 on the two separate sessions. If one session such as the backhaul wireless communication link 22 goes down that does not negatively affect the session between the mobile router 22 and the mobile device 16. As a result, processor 40 executing session proxy program module 54 maintains a TCP session to mobile device 16. If applications running on mobile device 16 are dependent upon a TCP session, the applications may continue to run because there is a TCP session with the mobile router 12, even though the TCP session over the backhaul wireless communication link 22 is lost. When communications via backhaul network communication link 22 are reestablished, mobile device 16 is able to keep running its applications and session without having to restart the applications.

When communication over backhaul network communication link 22 is interrupted, processor 40 executing session proxy program module 54 prevent the TCP session for wireless communication link to mobile device 16 from starting its back-off timers. Under TCP protocol, mobile device 16 would normally assume that it cannot forward packets because of network congestion and it would accordingly start to slow down the session. In contrast, processor 40 executing session proxy module 54 maintains a TCP session between mobile router 12 and mobile device 16. Mobile 16 device does not assume that network congestion is a problem and the TCP session between mobile router 12 and the mobile device 16 does not slow down.

Execution of session proxy module 54 by processor 40 may be disabled by mobile device via a control panel for the mobile router 12 displayed on the mobile device. A user can disable execution of session proxy program module 54 when the user wants to maintain a TCP session with the destination.

Processor 40 when executing serial port data publisher module 56 makes data received at serial interface 38 available from the mobile router 12 as a TCP stream or as some other type of data stream, such as HS-TCP or SCPS data stream.

Via backhaul network 20 and Internet 18, a remote database may be populated with the data received at serial interface 38 from device 36 so that data from serial device 36 can be remotely accessed via the Internet 18.

Serial device 36 may communicate with mobile router 12 using any suitable serial data protocol, including the USB (Universal Serial Bus) standard, the RS-232 standard, the RS-485 standard, the IEEE 1394 (FireWire) standard, or the Controller Area Network (CAN) bus standard, for example.

Serial device 36 may be any suitable type of serial device, such as, for example, a GPS receiver from anywhere on the Internet. Other types of serial data devices 36 may be used. Serial device 36 may be a vehicle telematics device that captures data regarding the performance and operation of the vehicle (e.g., diagnostic data) in which the device is installed. Serial Device 36 may in some embodiments comprise a CAN bus. In further embodiments, serial device 36 may be a point-of-sale (POS) device that captures sale or payment information.

Serial device 36 may also be a remote control for an in-car entertainment system that enables downloading music, video, games, etc., to third party systems or a device for interfacing to communication systems.

Rather than transmitting the data to a central server, e.g., database 25, a remote user could access mobile router 12 to access the data from serial interface 38, or CAN bus or serial device 36, directly. In one embodiment, an authenticated remote user could access an authentication server 23 as shown in FIG. 1 to determine the address of the mobile router 12. The remote user could then use that address to communicate with the mobile router 12 directly. Similarly, a local end-user of the mobile router 12 could access the data from CAN bus or serial device 36 via the local wireless network 14.

Processor 40 can output data and command signals via serial interface 38 to a CAN bus or serial device 36. Utilizing serial interface 38 and an attached CAN bus, processor 40 may activate and control various components and/or systems of a vehicle. Serial device or CAN BUS 36 may be able to shut of the vehicle engine, unlock the doors, activate alarm functions, etc. Serial device 36 may also, according to various embodiments, perform payment functions, download data, receive advertising, entertainment, gaming, and/or information, as well as perform network management and control.

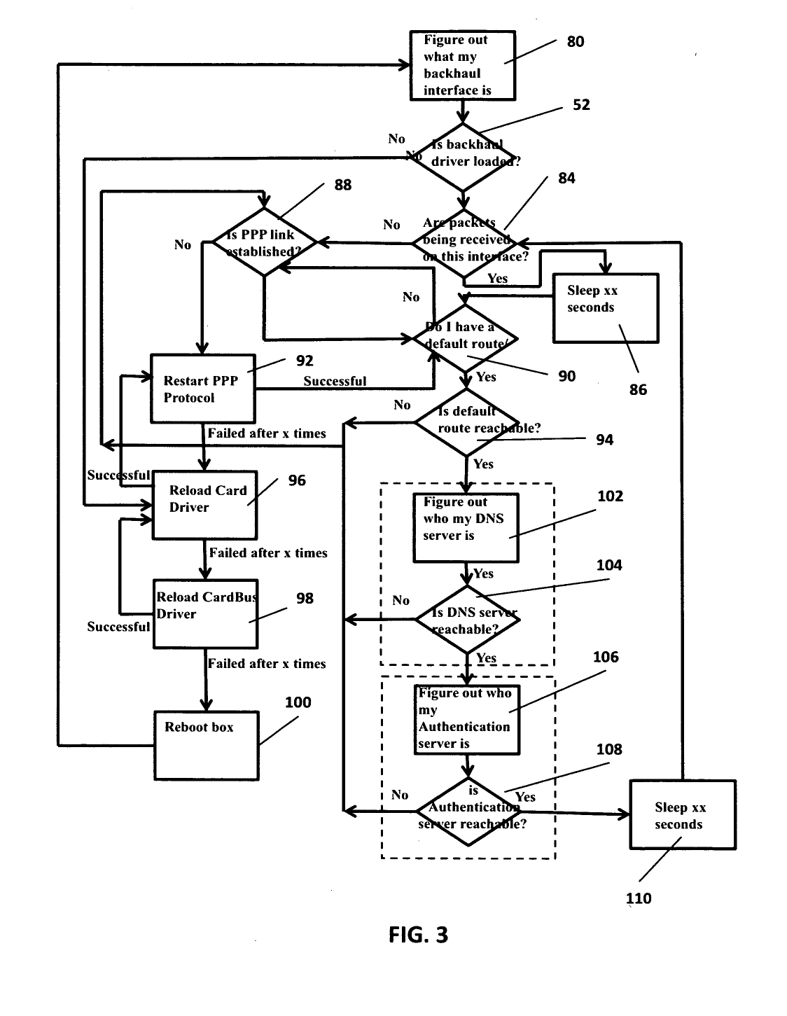

In the embodiment described above in conjunction with FIGS. 1 through 3, mobile router 12 operates as a WiFi access point that allows WiFi clients such as mobile device 16 to gain access to the Internet via cellular wireless link 22. As is evident to those skilled in the art, local network interface 46 comprises a WiFi compliant transceiver, the antenna of which is shown.

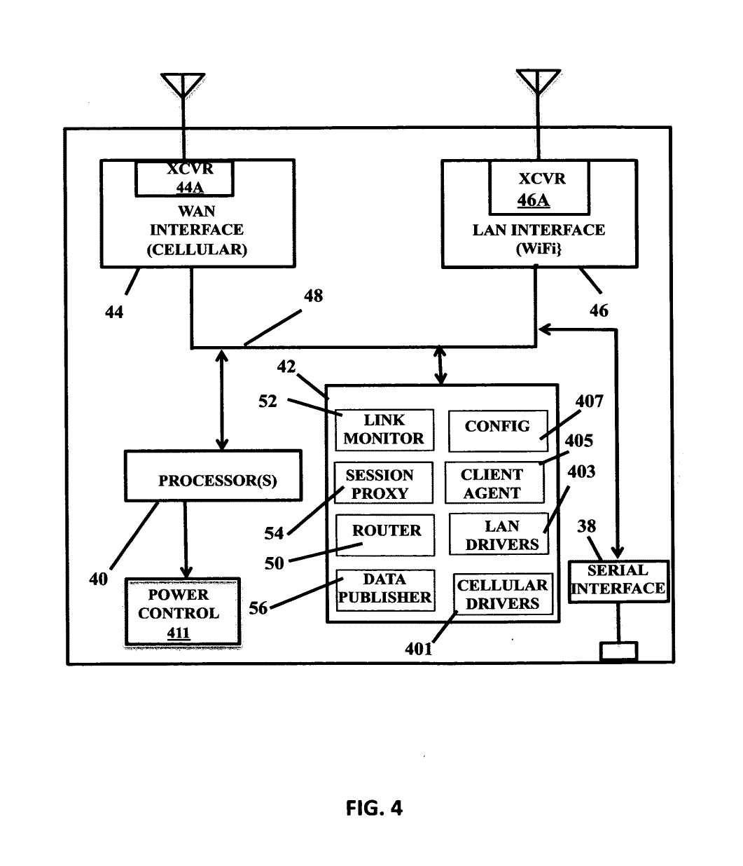

Turning now to FIG. 4, mobile router 12 is shown in further detail. In particular, local area interface 46 is expanded in detail to show a wireless transceiver 46a and interface 44 is expanded in detail to show a wireless transceiver 44A.

Wireless transceiver 46a is utilized to provide wireless communication to local area network 15 and provides the wireless link 14 thereto. As pointed out hereinabove, wireless transceiver 46a is compliant with one or more of industry standards for local area networks such as, for example, the IEEE standards for WiFi and WiMax. In the particular embodiment shown, the commonly used WiFi standard is utilized.

Utilizing WiFi transceiver 46A, mobile router 12 is also capable of acting as a client utilizing its WiFi transceiver to connect to other WiFi “hotspots.”

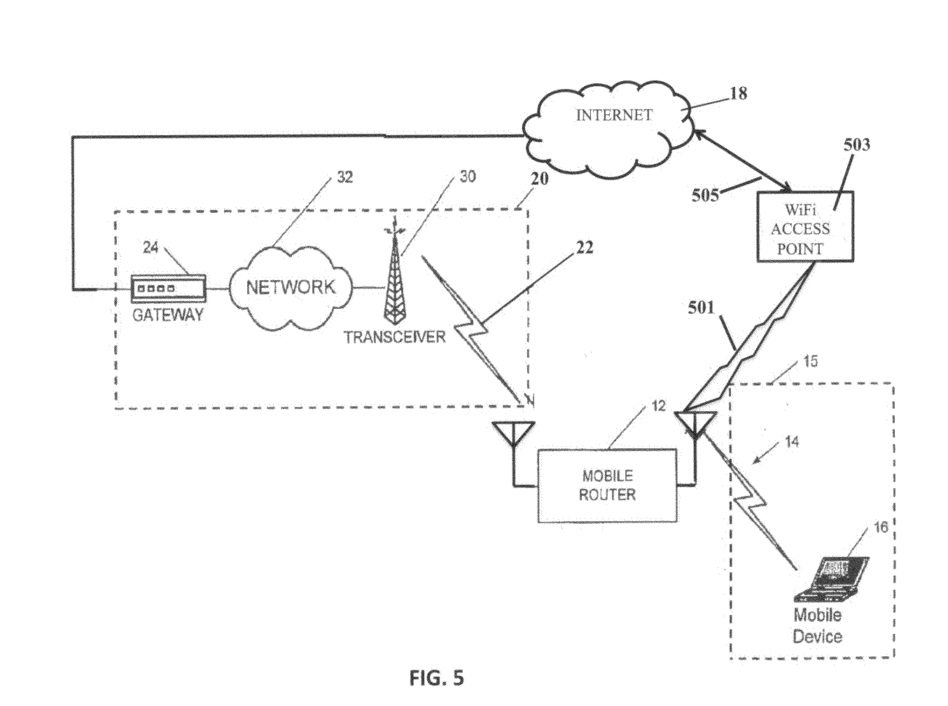

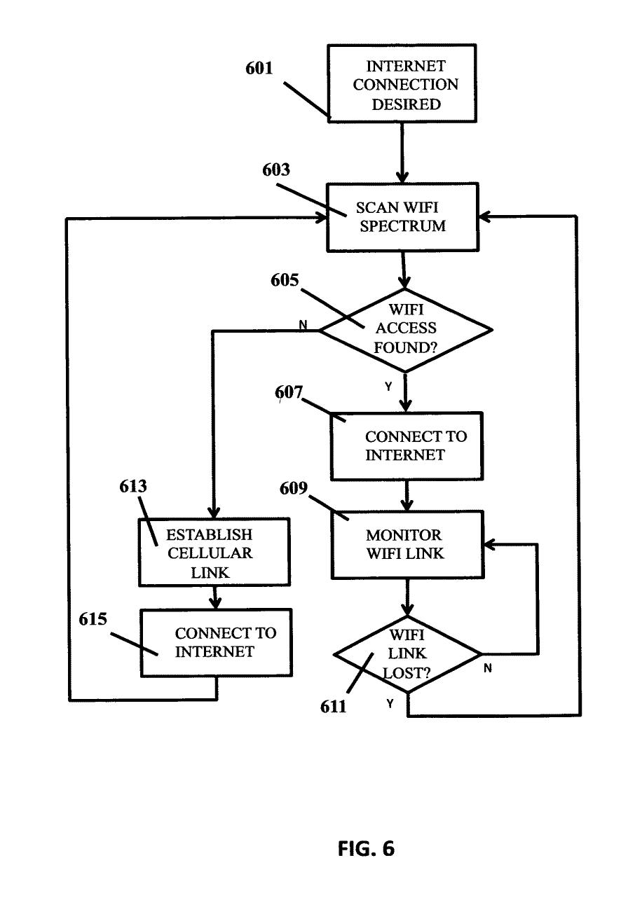

A novel aspect of mobile router 12 is illustrated in block diagram form in FIG. 5 and in the process flow diagram of FIG. 6. In particular, when mobile device 16 attempts to access Internet 18 at step 601, mobile router 12 makes advantageous use of its WiFi wireless transceiver 46A to first determine whether a local access network or WiFi Internet access point 503 is available by scanning the WiFi spectrum at step 603. It will be appreciated by those skilled in the art that the scan function may be provided as part of transceiver 46A or in combination with processor 40. In the event that a local access network or WiFi Internet access point 503 is identified at step 605, mobile router 12 establishes a wireless communication link 501 to WiFi access point 503 that in turn is coupled to Internet 18 via a link 505 to thereby establish an Internet connection at step 607. Link 505 may be any conventional link that is used by Internet access points. For as long as mobile device 16 is communicating via Internet 18 and for as long as a communication link 501 to WiFi access point 503 is operational, mobile router 12 maintains communication to WiFi access point 503. This is illustrated by step 609 at which the WiFi link is monitored and at step 611 which determines if the WiFi link is lost or becomes non-operational.

In the event that communication link 501 becomes non-operational, mobile router 12 scans for the availability of another local area network or WiFi access point at step 603. If another local area access or WiFi access point is identified at step 605 and it has connectability to the Internet 18, mobile router 12 will establish a new communication link 501 with the new WiFi access point 503 at step 607.

In the event that no local area or WiFi access point is identified by mobile router 12 at step 605, mobile router 12 utilizes backhaul network interface 44 to access a cellular network connection to the Internet 18 as described above and as shown as step 613 and connects to the Internet at step 615.

Even though mobile router 12 establishes a connection to the Internet, it continues to scan the WiFi spectrum for an alternate WiFi Internet connection.

By utilizing mobile router 12 to access a WiFi access point to establish an Internet connection, clients connected to mobile router 12 can obtain higher speed connectivity. In addition, since there is no cellular phone connectivity for such Internet connections, the costs of providing the Internet connection are reduced.

It will be appreciated by those skilled in the art that although the above embodiment describes the use of a WiFi transceiver and access point that mobile router 12 may connect mobile device 16 to any wireless local area network access point by providing a configurable transceiver and selectable drivers 403 shown in FIG. 4. Mobile router 12 includes drivers 403 that correspond to various industry standards such as the standards for WiFi and for WiMax and will select the appropriate driver based upon the type of wireless access point available.

In another advantageous embodiment, mobile router 12 may be utilized to automatically provide synchronized downloads of predetermined content from various commercial sources of such predetermined content. By way of example, a vehicle equipped with mobile router 12 can obtain predetermined download copies of specific content such as movies or music.

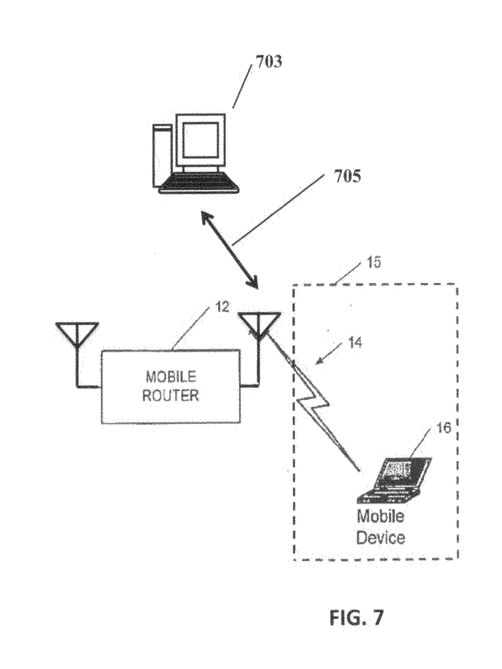

Turning now to FIG. 7, mobile router 12 is provided with a wireless local area network interface as described above. A base computer or server 703 is provided with a compatible wireless transceiver and has access to digital files of predetermined content.

In one illustrative embodiment, base computer 703 is located, for example, at a gasoline service station. Base computer 703 is provided with a data synchronization program. When mobile receiver 12 is within wireless communication range with base computer 703, a wireless LAN connection is established automatically via a wireless link 705. Upon establishment of the wireless LAN connection various predetermined entertainment content digital data is automatically synchronously downloaded from base computer 703 to mobile device 16 via wireless link 705, mobile router 12 and wireless link 14.

By way of example, an agreement may exist between the supplier of mobile router services and, using the example above, the gasoline service station such that the owner or user of mobile router 12 receives free downloaded movies or other content each time the owner or user gases up at the service station.

In another embodiment, base computer 703 is located at the home or residence of the owner or user of mobile router 12, or the residence of the owner or user of mobile device 16. When the vehicle containing mobile router 12 returns home, mobile router 12 automatically receives a synchronized download of content from base computer 703. The content is directed to mobile device 16 and may include various predetermined entertainment type content such as movies, videos, audio files or any other types of files that has been predetermined for synchronized download to mobile device 16.

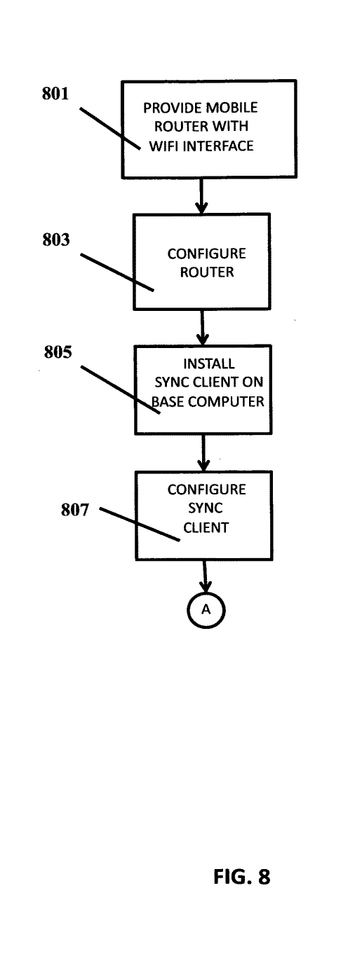

Mobile router 12 and base computer 703 are set up to provide synchronized downloads. Turning now to FIG. 8, mobile router 12 is provided with a WiFi interface at step 801 and is configured at step 803 to identify the mobile device 16 or mobile devices that are to receive synchronized content. A configuration program module 407 shown in FIG. 4 is loaded into mobile router 12 to provide configuration control along with synchronization agent 405.

A synchronization client is installed at step 805 on base computer 703. At step 807, the sync client is configured to identify the specific mobile device 16 or devices that are to receive synchronized downloads and to also identify the content to be synchronized to mobile device 16 or devices. In addition, particular characteristics of each mobile device that is to receive synchronized downloads are provided to base computer 703. One example of such a characteristic is the memory available on the mobile device 16 or devices. Alternatively, the memory may be the memory in a vehicular entertainment system or systems.

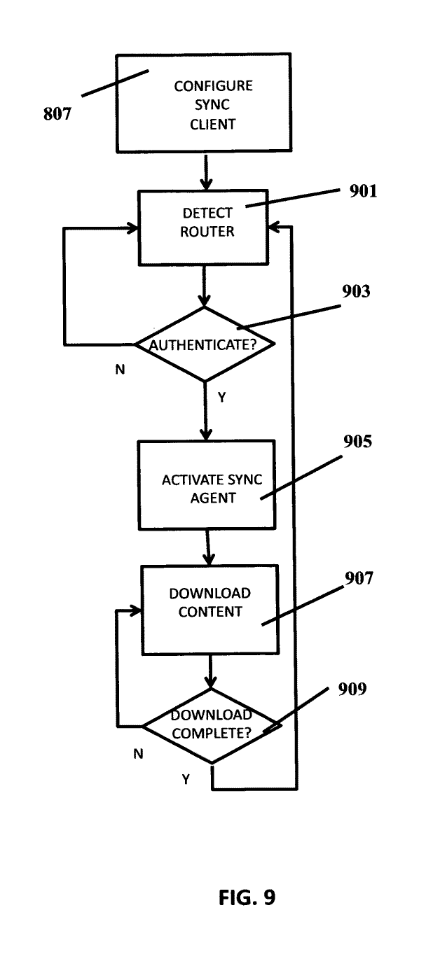

Turning now to FIG. 9, operation of the base computer 703 is illustrated. After the synchronization client is configured at step 807, base computer 703 monitors its WiFi transceiver. Upon detecting mobile router 12 at step 901, base computer 703 first authenticates the mobile router at step 703 and then activates the synchronization agent or program at step 905. Base computer 703 downloads the predetermined content to mobile device 16 via mobile router 12 at step 907 until the download is complete at step 909.

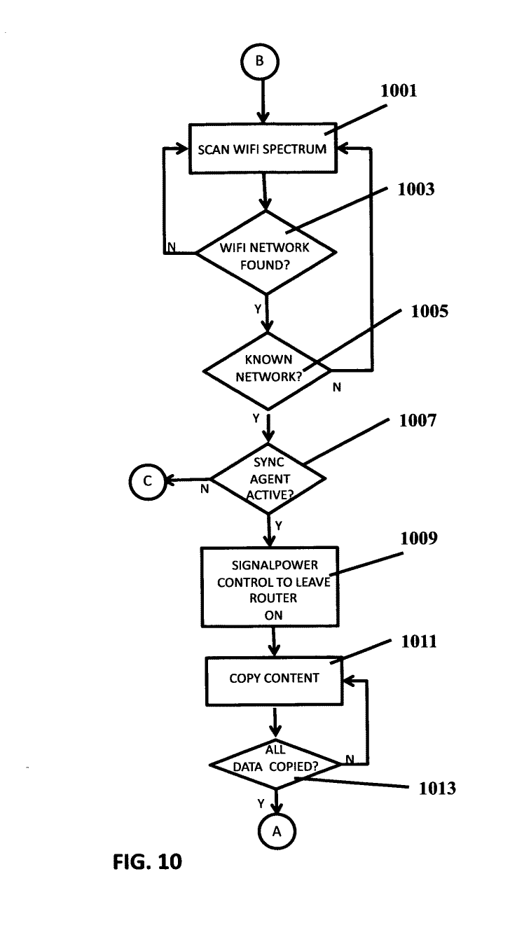

The operation of mobile router 12 is shown in FIG. 10. Mobile router 12 utilizes its WiFi transceiver 46A to scan the WiFi spectrum at step 1001 until a WiFi network is found at step 1003. Upon detecting a WiFi network, mobile router 12 determines whether the detected network is a known network at step 1005. If the network is a known network and further if its synchronization agent is determined to be active at step 1007, mobile router 12 at step 1009 signals a power control circuit 411 shown in FIG. 4 to maintain power to mobile router 12. The predetermined content from base computer 703 is then downloaded to mobile device 16 via mobile router 12 at step 1011. The downloading is continued until the entirety of the predetermined content is downloaded at step 1013.

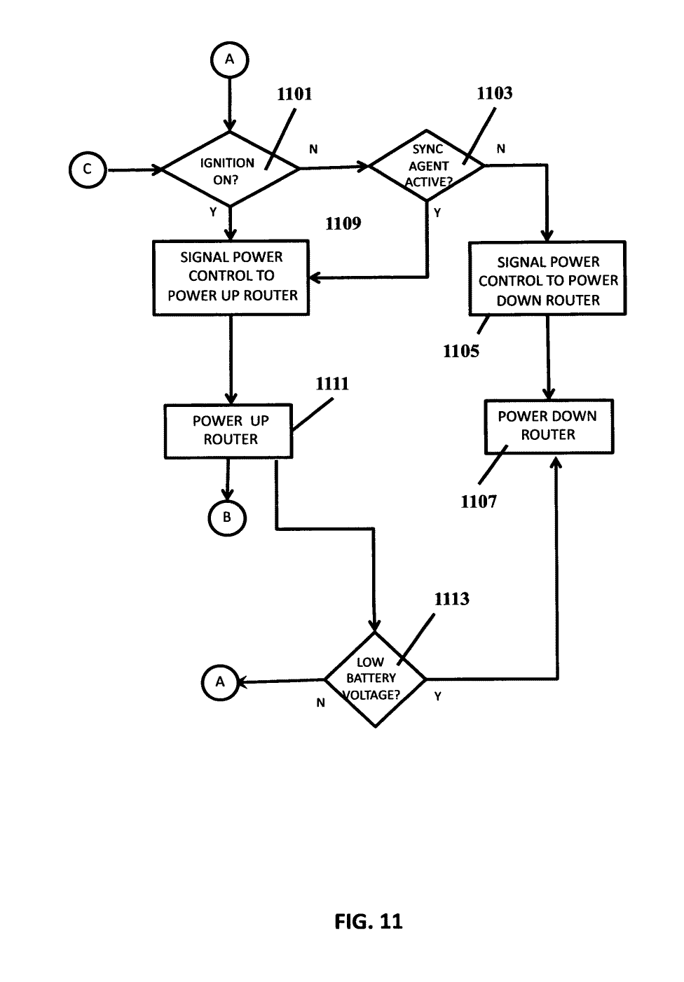

Turning now to FIG. 11, the operation of power control 411 is shown. Initially, at step 1101 a determination is made as to whether the vehicle ignition is on. If the ignition is turned on power control 411 is signaled at step 1109 to power up mobile router 12 and mobile router 12 is powered up at step 1111.

In the event that the vehicle agent ignition is off at step 1111, a determination is made as to whether the synchronisation agent 405 of mobile router 12 is active at step 1103. If synchronization agent 405 is active, a signal is sent to power control 411 to power up mobile router 12. If synchronization agent 405 becomes inactive, then a signal is sent at step 1105 to power down mobile router 12 and at step 1107, mobile router 12 is powered down.

Whenever mobile router 12 is powered up at step 1111, the vehicle battery voltage is monitored at step 1113. If the battery voltage is not low, mobile router 12 stays powered up, but if the battery voltage is low, a signal is again sent to power down mobile router at step 1105 and mobile router 12 is again powered down at step 1107.

As used herein, the term “mobile device” may comprise a “mobile device,” a “serial device,” a “CAN bus,” or other devices.

It will be appreciated by those skilled in the art that various changes and modifications may be made to the embodiments described herein without departing from the spirit or scope of the invention. It is intended that the invention not be limited in any way by the embodiments shown and described herein, but that the invention be limited only by the claims appended hereto.

What is claimed is:

1. A method of utilizing a mobile router of a type comprising a local area network interface comprising a first wireless transceiver of a predetermined type to provide a link to a local area network, a wide area network interface comprising a second wireless transceiver of a second predetermined type to provide a link to a wide area network, a processor to control operation of said router, and a memory comprising programs executable by said processor, said method comprising:
selectively operating said router as a wireless local area network access point for a first client device utilizing said first transceiver to access the Internet via a wide area network and said second transceiver;
selectively operating said router as a local area network client utilizing said first transceiver for said first client device to access download sources accessed via said local area network transceiver;
automatically downloading predetermined data to said client device from a second client device; and
automatically synchronizing the downloading of said predetermined data.

2. A method in accordance with claim 1, comprising:
providing entertainment source data as said predetermined data.

3. A method in accordance with claim 1, comprising:
operating said second client and said first client to automatically synchronize downloading of said predetermined data from said second client device to said first client device.

4. A method in accordance with claim 1, comprising:
selecting said second client as a commercial enterprise; and
selecting said first client as a customer of said commercial enterprise.

5. A method in accordance with claim 4, comprising:
providing said first client with identification information;
operating said second client to automatically verify said identification information prior to said automatic downloading.

6. A method in accordance with claim 1, comprising:
checking identification information of said first client by said second client prior to said downloading.

7. A method in accordance with claim 6, comprising:
utilizing said identification information to determine said predetermined data.

8. A method of operating a mobile router comprising a local area network transceiver and a wide area network transceiver, said method comprising
selectively operating said mobile router as a wireless local area network access point for a mobile device to access the Internet via wide area network wireless transceiver;
selectively operating said mobile router as a local area network client utilizing said transceiver for said client device to access a download source accessed via said local area network transceiver; and
automatically downloading predetermined data to said client device from a second client device.

9. A method in accordance with claim 8, comprising:
providing video data as said predetermined data.

10. A method for providing videos to customers, comprising:
providing a source of said videos as digital data;
providing said source with a first wireless transceiver of a predetermined type utilizable in local area networks;
detecting a mobile router having a second wireless transceiver of said predetermined type to provide a link to a local area network, said local area network comprising a customer mobile device; and
operating said video source and router such that said video source automatically downloads video digital data to said customer mobile device via said wireless local area network and said router.

11. A method in accordance with claim 10, comprising:
providing said mobile router and said customer mobile device in a vehicle.

12. A method in accordance with claim 11, comprising:
automatically synchronizing said download of video digital data.

13. A method in accordance with claim 10, comprising:
providing configuration information to said mobile router with configuration information for said video digital data source.

14. A method in accordance with claim 13, comprising:
providing said video digital data source with a synchronization client.

15. A method in accordance with claim 14, comprising:
configuring said synchronization client to identify specific video digital data to be downloaded to said customer mobile device.

16. A method in accordance with claim 10, comprising:
providing said video digital data source with said first wireless transceiver complying with a recognized standard for local wireless networks; and
wherein said router second wireless transceiver is compliant with said recognized standard.

17. A method in accordance with claim 16, comprising:
selecting said recognized standard as the IEEE standard for WiFi.

18. A method for providing digital entertainment to a customer having a mobile router comprising a first wireless local area network having a customer mobile device coupled thereto, said method comprising:
providing a source of said digital entertainment data;
coupling said source to said customer mobile device via said router and said first wireless local area network;
operating said source with said router such that said source automatically downloads predetermined digital entertainment data to said customer mobile device via said wireless local area network and said router.

19. A method in accordance with claim 18, comprising:
providing said mobile router and said customer mobile device in a vehicle.

20. A method in accordance with claim 19, comprising:
providing automatic synchronization of said download of said predetermined digital entertainment data.

21. A method in accordance with claim 20, comprising:
providing said source with a synchronization client.

22. A method in accordance with claim 21, comprising:
configuring said synchronization client to said predetermined entertainment data to be downloaded to said customer mobile device.

23. A method in accordance with claim 22, comprising:
providing said source with a first wireless transceiver compliant with a recognized standard for local wireless networks; and
wherein said router comprises a second wireless transceiver compliant with said recognized standard.

24. A method in accordance with claim 23, comprising:
selecting said recognized standard as the IEEE standard for WiFi.
